(19) United States
(12) Patent Application Publication
(10) Pub. No.: US 2004/0074737 A1
(43) Pub. Date: Apr. 22, 2004

(54) Coin differentiating unit of coin dispenser

(75) Inventor: Wen-Fu Yang, Taipei City (TW)

Correspondence Address: BACON & THOMAS, PLLC, 625 SLATERS LANE, FOURTH FLOOR, ALEXANDRIA, VA, 22314

(73) Assignee: INTERNATIONAL CURRENCY TECHNOLOGIES CORPORATION, Taipei (TW)

(21) Appl. No.: 10/274,142

(22) Filed: Oct. 21, 2002

(51) Int. Cl. G07D 5/02

(52) U.S. Cl. 194/338

(57) ABSTRACT

The coin differentiating unit comprises a case, a detecting device, a first motor set, a second motor set and a dispensing plate. The case comprises a coin differentiation area and a coin collection area. The coin collection area comprises a groove. The groove comprises a coin identifying plate and a coin over-load dispensing plate pivotally mounted there within. And the coin collection area comprises a plurality of coin channels comprising a partition plate in between two adjacent coin channels. A circuit board and the detecting device are positioned inside the differentiation area of the case. A plurality of detecting elements is positioned over the circuit board. The first and second motor sets are used to control the coin identifying plate and the coin-overload dispensing plate for differentiating the real coins from phony coins and for closing the coin collection case when the coin collection case is over-loaded with the coins.

### BACKGROUND OF THE INVENTION

1. Field of the Invention

The present invention relates to a coin dispenser, and more particularly, the present invention relates to a coin differentiating unit of a coin dispenser that comprises a coin identifying plate which can open or close to differentiate the real coins from the phony coins and lead the coins into a coin collection case, and a coin over-load dispensing plate which can close the coin collection case, when the coins in the coin collection case is full and to its maximum capacity.

2. Description of the Related Art

Due to the rapid advancement in technologies, a greater need for an improved and good quality automatic vending machines such as merchandising vending machine, ticketing vending machine and auto-coin exchanger that are commonly installed in public facilities for publics' convenience and prompt service. The use of these vending machines could substantially reduce the labor cost. The convenience offered by these machines indeed increases the acceptance from users. The above-mentioned vending machines comprise a coin dispenser inside for leading the coins inputted by the user into a coin collection case. Referring to FIGS. 6 and 7, shows a conventional coin differentiating unit A comprising a main case A1 and solenoid A2. The main case A1 comprises a coin channel A11 and the solenoid A2 is pivotally positioned at an exit of the coin channel A11. The solenoid A2 can be operated to rotation through a certain angle by an electromagnetic switch A21. A gate A22 positioned at a frontal side of the solenoid A2 can change the direction of falling coins B in the coin channel A11 in order to lead the coins into appropriate coin storing cases. However, the above-mentioned conventional coin dispenser functions by turning the solenoid A2 ON and OFF, therefore the solenoid A2 operates between two points, and therefore the speed and outgoing force of the inserted coin cannot be controlled. Furthermore, as the electromagnetic switch A21 is turned on and off repeatedly, and since the output force each time the electromagnetic switch A21 is turned on and off is not same, thus about 90% of the electric power is exhausted, this results in a larger consumption of electric power. Thus the operating cost is high. Further, even a minor difference or clash during the assembling could adversely affect the functioning of the electromagnetic switch A21 and thereby an error in leading the inserted coin B to the proper direction and location. For overcoming this defect of the electromagnetic switch A21, an additional motivator, a stopping detecting sensor and a control circuit are necessary. However, above improvement will certainly increase the cost.

Accordingly, a new improved cost effective coin differentiating unit is highly desirable.

### SUMMARY OF THE INVENTION

Accordingly, in the view of the foregoing, the present inventor makes a detailed study of related art to evaluate and consider, and uses years of accumulated experience in this field, and through several experiments, to create a coin differentiating unit of the present invention. The present invention provides an innovated cost effective coin differentiating unit of a coin dispenser comprising a coin identifying plate which can open or close to differentiate the real coins from the phony coins and lead the coins into a coin collection case, and a coin over-load dispensing plate which can close the coin collection case, when the coins in the coin collection case is full and to its maximum capacity.

In order achieve the above objects and other objects of the present invention, a coin differentiating unit of a coin dispenser is provided. The coin differentiating unit comprises a case, a detecting device, a first motor set, a second motor set and a dispensing plate. The case comprises a coin differentiation area and a coin collection area. The coin collection area comprises at least a groove. The groove comprises a coin identifying plate and a coin over-load dispensing plate pivotally mounted there within. And the coin collection area comprises a plurality of coin channels comprising a partition plate in between two adjacent coin channels.

A circuit board and the detecting device are positioned inside the differentiation area of the case. A plurality of detecting elements is positioned over the circuit board. An insertion lid is positioned above the detecting device.

According to an aspect of the present invention, the first motor set is set on the base and is positioned behind the coin collection area of the case. A motor is positioned on a rear side of the base. The motor comprises a axial biasing protruded roller, and the biasing protruded roller comprises a first protruded roller and a second protruded roller, wherein a radius of the a first protruded roller is larger than a radius of the second protruded roller. The first protruded roller is set against the coin identifying plate and the second protruded roller is set against the coin over-load dispensing plate.

According to another aspect of the present invention, the second motor is set on a base plate and positioned behind the differentiation area of the case. Two motors are positioned on the base plate. Two roller sets are axially set on the motor. Each of the roller sets comprises a master roller, wherein a blocking device is axially disposed on the master roller. Two slave rollers are positioned axially on the blocking device for opening or closing the partition plate of the coin channel.

According to another aspect of the present invention, the dispensing plate is positioned on the surface of the collecting area of the case. The dispensing plate comprises a leading face extending outwardly from one of its sides, and a blocking plate projecting from a surface of the dispensing plate.

According to another aspect of the present invention, when a coin inserted into a insertion slot, the detecting device will identify whether the coin is phony, and if the coin is phony, the detecting device will output a signal for activating the motor of the first motor set to drive and roll the biasing protruded roller, to enable the first protruded roller to release the coin identifying plate and make the coin identifying plate rotate inwardly to rest against the side of the collecting area, thus the coin identifying plate in a declined position. As a result, the coin that has been detected as phony by the detecting device will be led by the coin identifying plate into the dispensing plate on the surface of the collecting area, and then the blocking plate of the surface of the dispensing plate will lead the coin into the phony coin collection case that is set outside the coin dispenser.

According to another aspect of the present invention, if the coin is identified to be real, the detecting device will output a signal to activate the motor of the first motor set to drive and roll the biasing protruded roller, to enable the first protruded roller to rotate the coin identifying plate and make the coin identifying plate rotate outwardly and position perpendicularly or positioned upright to enable the coin identifying plate to lead the coin into the plurality of the coin channel that are positioned at the lower side of the coin collecting area, and further to enter to the coin collection case of the coin ejecting unit. When the coin collection case is full with coins, then the blocking device of the second motor set will output a signal to activate the motor of the second motor set commanding the master roller, the blocking device and the slave roller in orderly fashion, for making the partition plate to close the over loaded coin channel. Furthermore, when the coin collection case of the coin ejecting unit is full with the coins, the motor of the first motor set will activate the biasing protruded roller for rotating, to make the edge of the second protruded roller rest against the coin over-load dispensing plate, and the coin over-load dispensing plate will rotate outwardly to rest against the back face of the leading face of the dispensing plate and in incline position. Meanwhile, the coin can be led by the coin identifying plate and the coin over-load dispensing plate to enter the groove of the collecting area, then the coin enters into the preset collecting channel which located on a side of the coin ejecting unit from the rear side of the base plate of the second motor set, and finally, the coin collected into a coin collection case located at an exit of the collecting channel to separate the real coins from the phony ones.

### BRIEF DESCRIPTION OF THE DRAWINGS

FIG. 1 is an exploded view of a coin dispenser including a coin differentiating unit of the present invention;

FIG. 2 is an elevational view of the coin dispenser including the coin differentiating unit of the present invention;

FIG. 3 is an exploded view of the of a coin differentiating unit of coin dispenser of the present invention;

FIG. 4 is an embodiment of the coin differentiating unit of coin dispenser showing while inserting a phony coin according to the present invention;

FIG. 4A is a sectional view of the coin dispenser showing inserting a phony coin into the coin dispenser according to the present invention;

FIG. 4B is an enlarged sectional view of FIG. 4A;

FIG. 5 is an embodiment of the coin dispenser while inserting a real coin into the coin dispenser according to the present invention;

FIG. 5A is a sectional view of the coin dispenser showing inserting a real coin into the coin dispenser according to the present invention;

FIG. 5B is an enlarged sectional view of FIG. 5A.

FIG. 5C is the sectional view of an embodiment of the coin dispenser showing when the coin collection case is over loaded according to the present invention;

FIG. 5D is an enlarged sectional view of FIG. 5C;

FIG. 6 is the side sectional view of a conventional coin dispenser; and

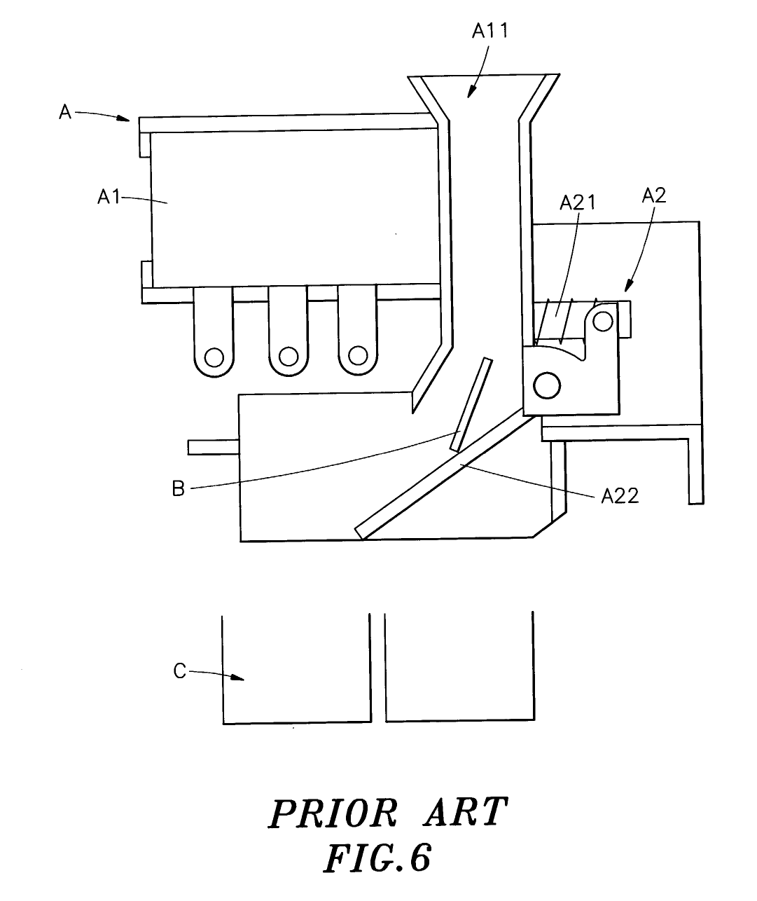

FIG. 7 is another side sectional view of the conventional coin dispenser.

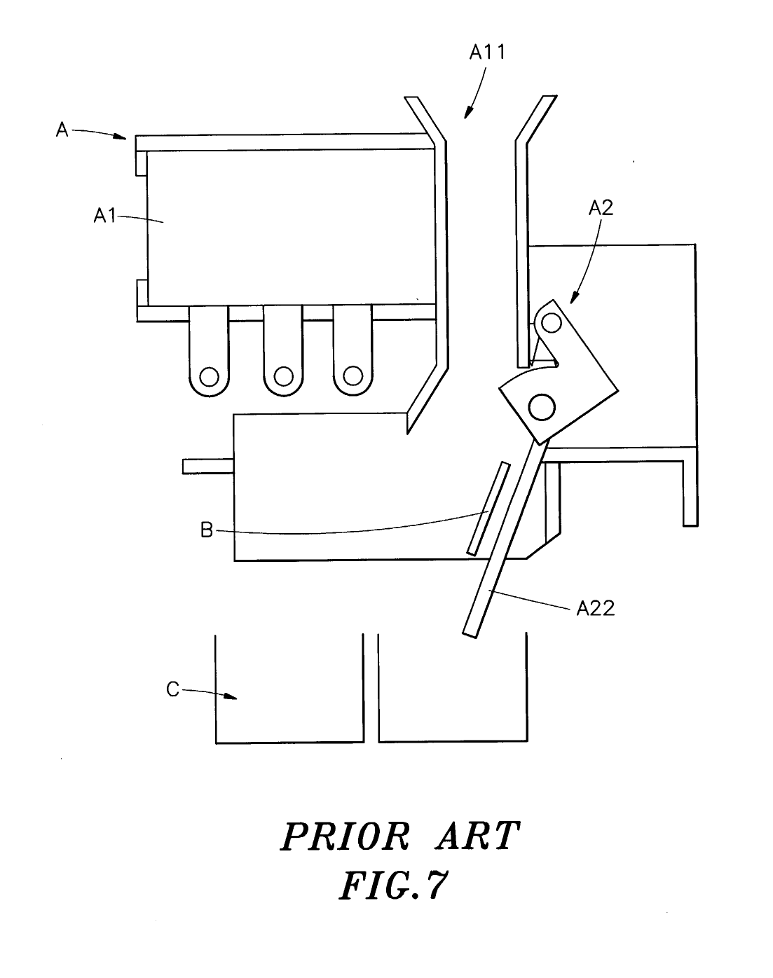

### DESCRIPTION OF THE PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

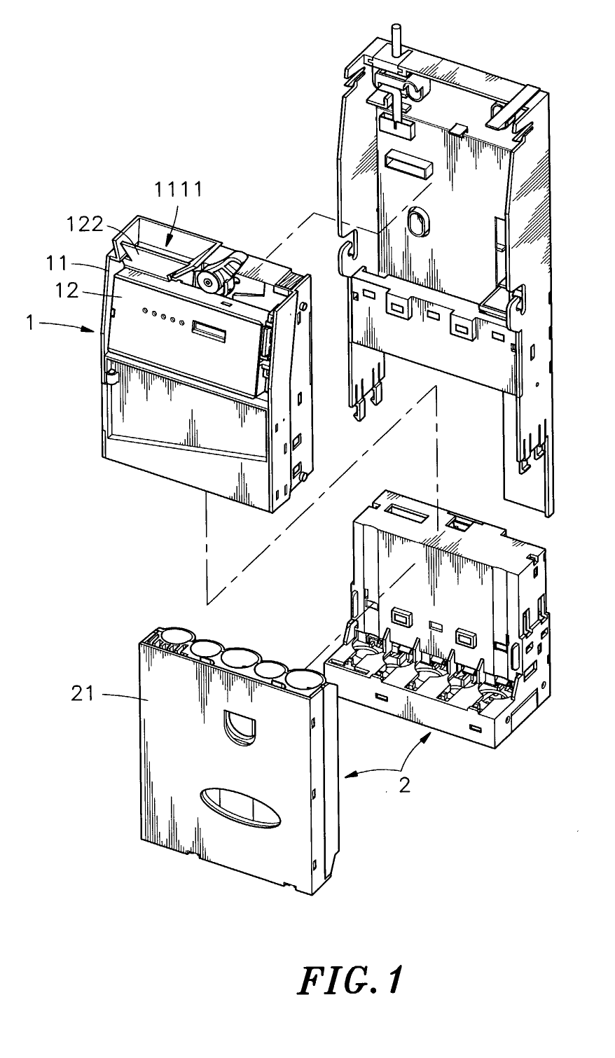

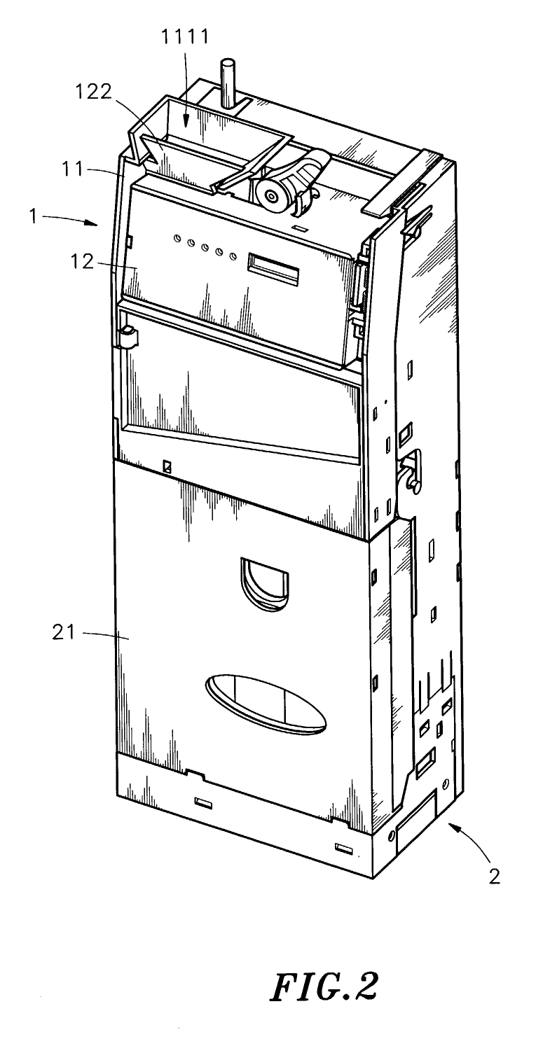

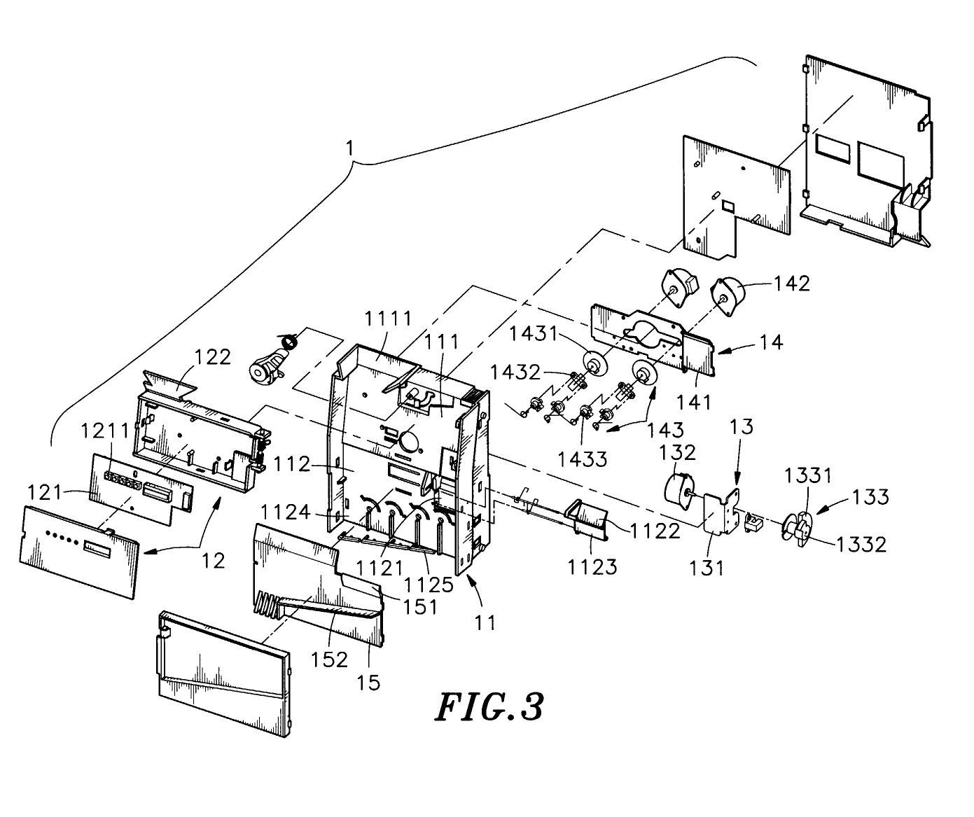

Referring to FIGS. 1, 2 and 3, the coin dispenser 1 of the present invention comprises a case 11, a detecting device 12, a first motor set 13, a second motor set 14 and a dispensing plate 15. The case 11 comprises a coin differentiation area 111 and a coin collection area 112. The coin collection area 112 comprises at least a groove 1121. The groove 1121 comprises a coin identifying plate 1122 and a coin over-load dispensing plate 1123 pivotally mounted there within. And the coin collection area 112 comprises a plurality of coin channels 1124 comprising a partition plate 1125 in between two adjacent coin channels 1124.

A circuit board 121 and the detecting device 12 are positioned inside the differentiation area 111 of the case 11. A plurality of detecting elements 1211 is positioned over the circuit board 121. An insertion lid 122 is positioned above the detecting device 12.

The first motor set 13 is set on a base 131 and is positioned behind the coin collection area 112 of the case 11. A motor 132 is positioned on a rear side of the base 131. The motor 132 comprises a axial biasing protruded roller 133, and the biasing protruded roller 133 comprises a first protruded roller 1331 and a second protruded roller 1332, wherein a radius of the a first protruded roller 1331 is larger than a radius of the second protruded roller 1332. The first protruded roller 1331 is set against the coin identifying plate 1122 and the second protruded roller 1332 is set against the coin over-load dispensing plate 1123.

The second motor 14 is set on a base plate 141 and positioned behind the differentiation area 111 of the case 11. Two motors 142 are positioned on the base plate 141. A roller set 143 is axially set on each of the motor 142. Each of the roller sets 143 comprises a master roller 1431, wherein a blocking device 1432 is axially disposed on the master roller 1431. Two slave rollers 1433 are positioned axially on the blocking device 1432 for opening or closing the partition plate 1125 of the coin channel 1124.

Further, the dispensing plate 15 is positioned on the surface of the collecting area 112 of the case 11. The dispensing plate 15 comprises a leading face 151 extending outwardly from one of its sides, and a blocking plate 152 projecting from a surface of the dispensing plate 15.

After assembling above-mentioned elements, a coin ejecting unit 2 with the coin collecting case 21 for practicing coin dispenser of the present invention.

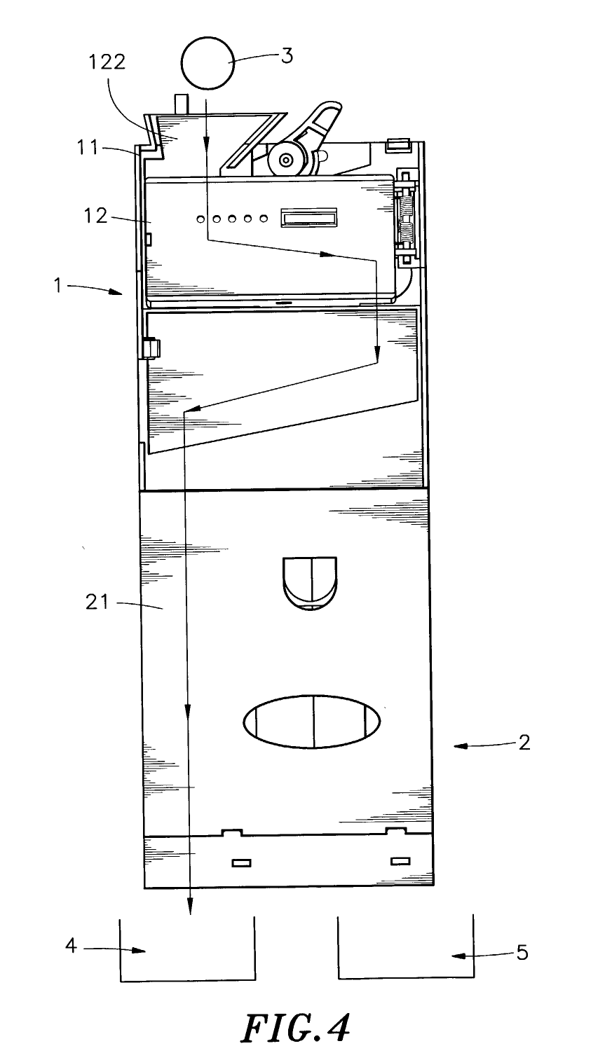

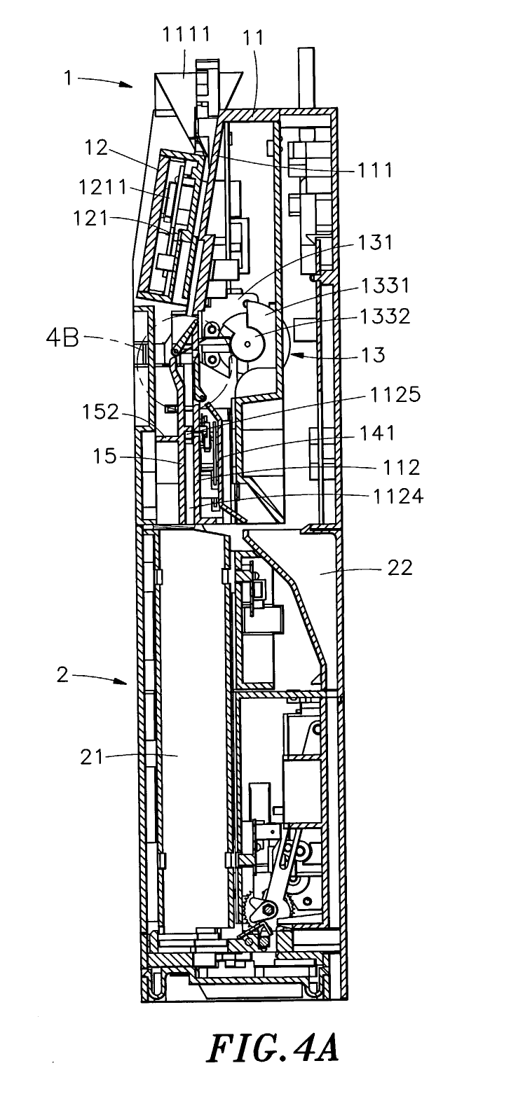

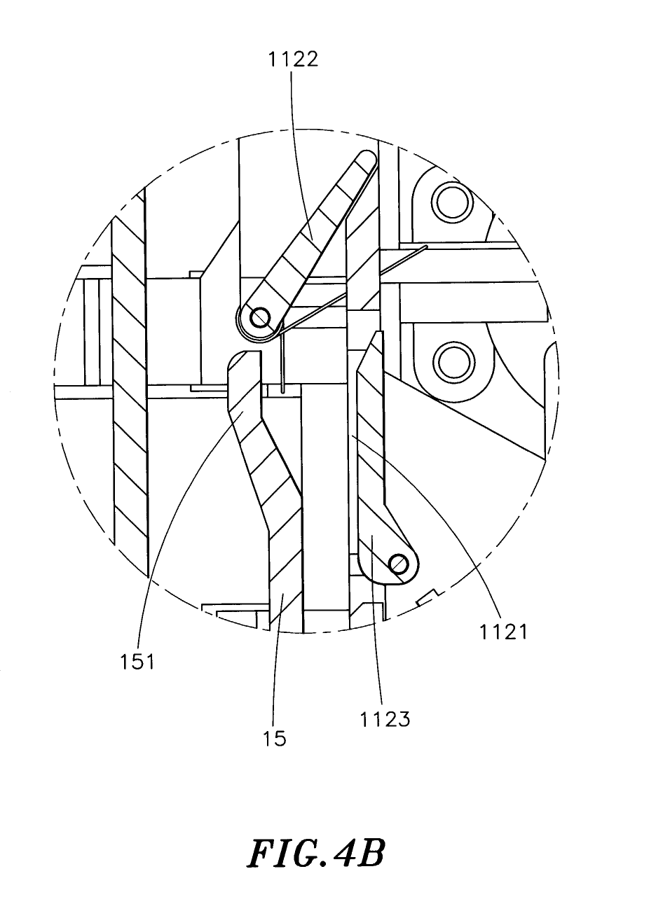

Referring to FIGS. 4, 4A and 4B, the actual operation of the coin dispenser of the present invention is described as follows. When a coin 3 inserted into an insertion slot 1111, the detecting device 12 will identify whether the coin 3 is phony, and if the coin 3 is phony, the detecting device 12 will output a signal for activating the motor 132 of the first motor set 13 to drive and roll the biasing protruded roller 133, to enable the first protruded roller 1331 to release the coin identifying plate 1122 and make the coin identifying plate 1122 rotate inwardly to rest against the side of the coin collection area 112, thus the coin identifying plate 1122 in a declined position. As a result, the coin 3 that has been detected as phony by the detecting device 12 will be led by the coin identifying plate 1122 into the dispensing plate 15 on the surface of the coin collection area 112, and then the blocking plate 152 of the surface of the dispensing plate 15 will lead the coin 3 into the phony coin collection case 4 that is set outside the coin dispenser 1.

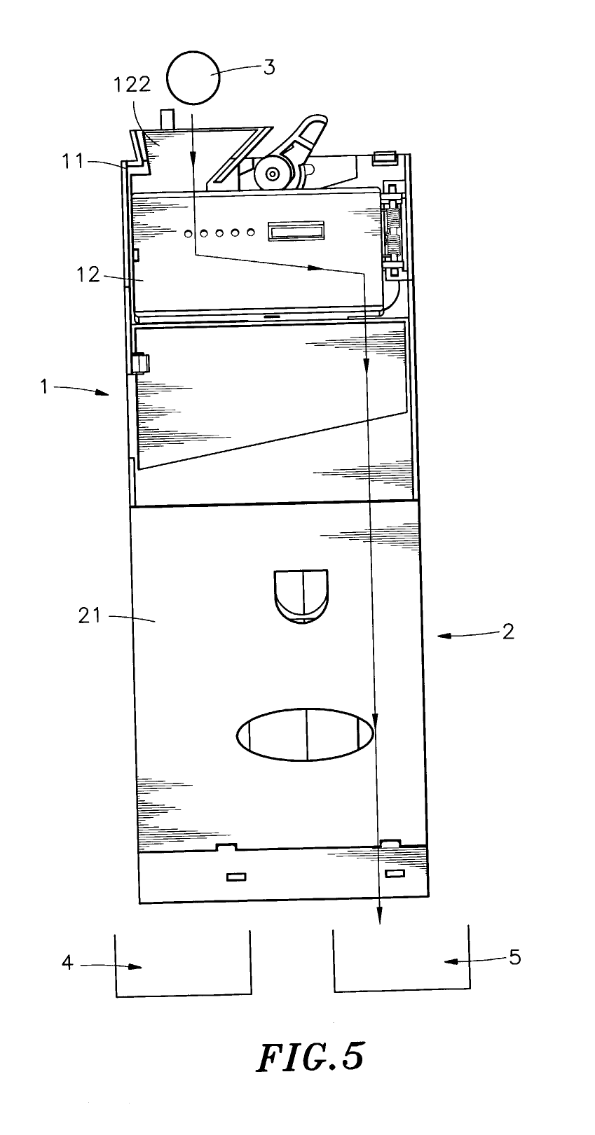

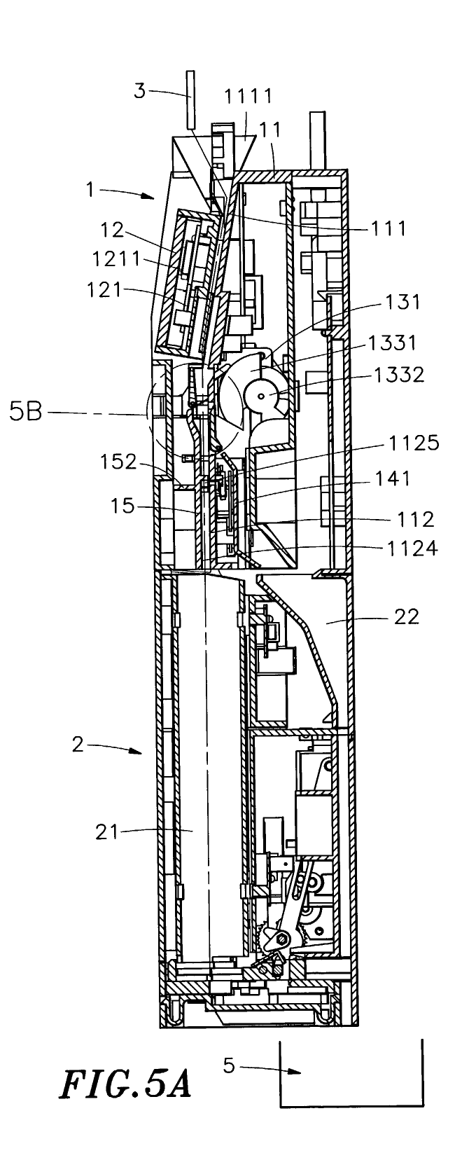

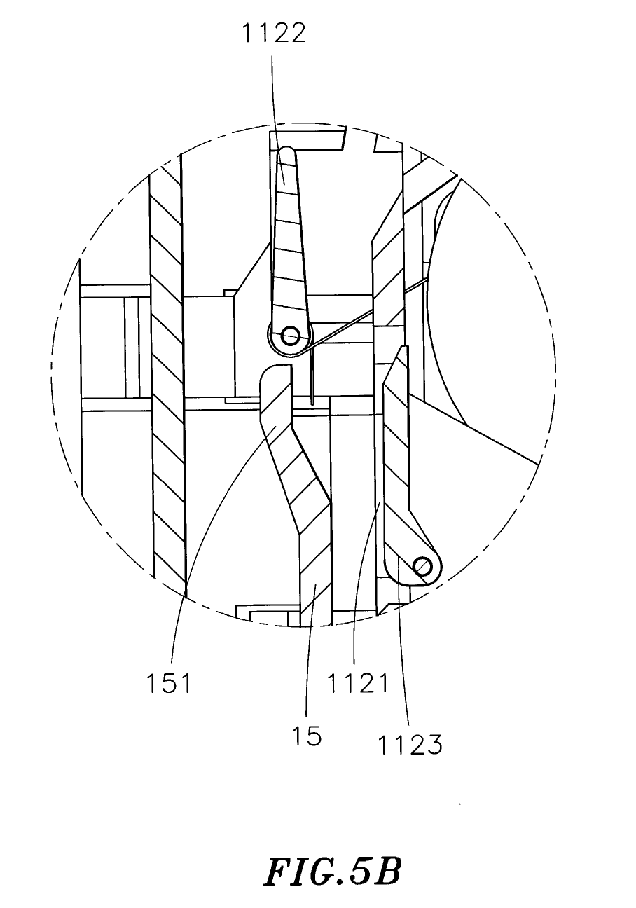

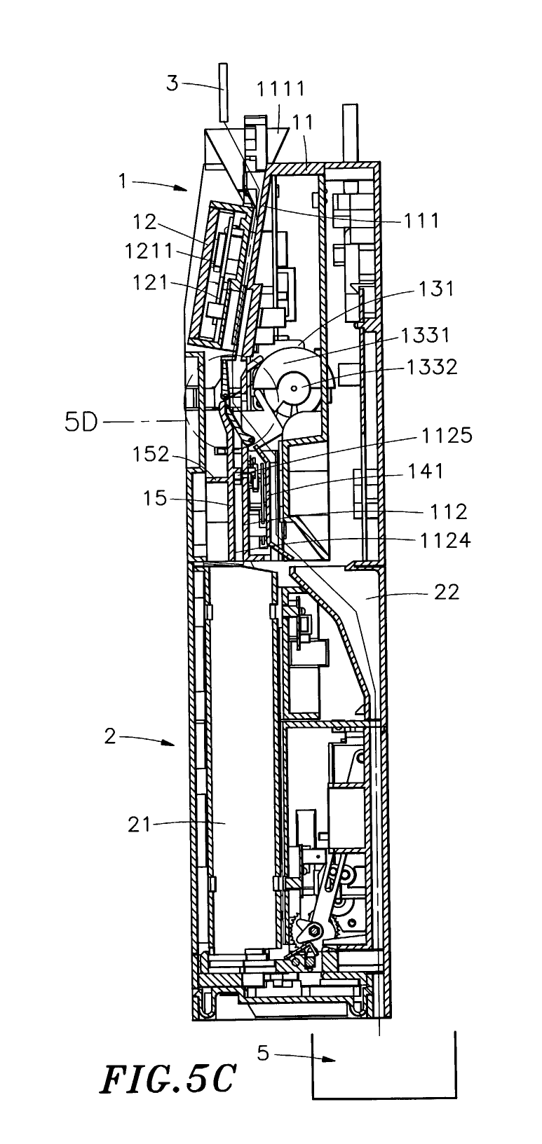

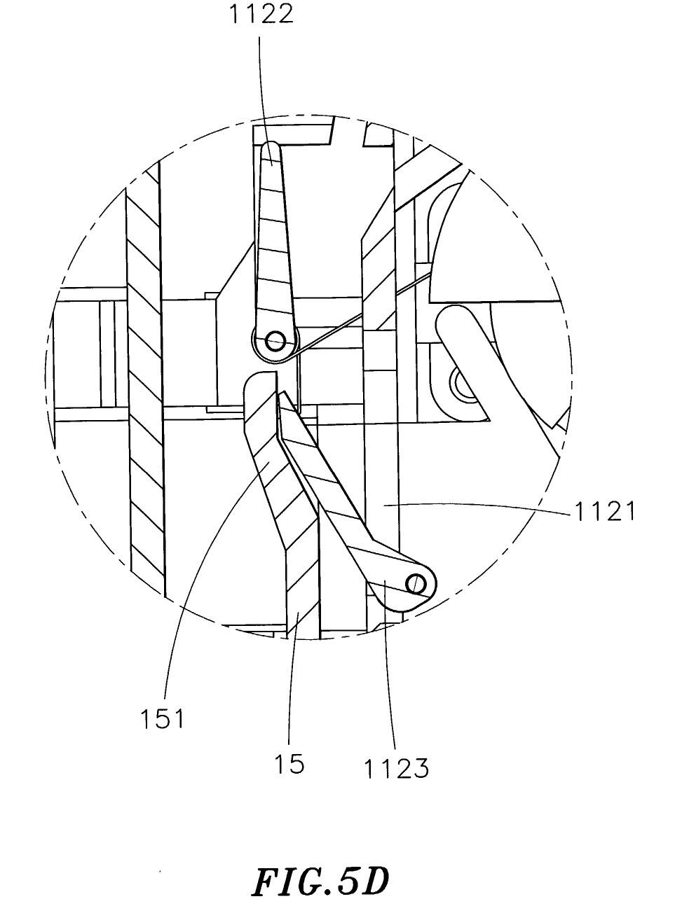

Further, referring to FIGS. 5, 5A, 5B, 5C and 5D, if the coin 3 is identified to be real, the detecting device 12 will output a signal to activate the motor 132 of the first motor set 13 to drive and roll the biasing protruded roller 133, to enable the first protruded roller 1331 to rotate the coin identifying plate 1122 and make the coin identifying plate 1122 rotate outwardly and position perpendicularly or positioned upright to enable the coin identifying plate 1122 to lead the coin 3 into the plurality of the coin channel 1124 that are positioned at the lower side of the coin collection area 112, and further to enter to the coin collection case 21 of the coin ejecting unit 2. When the coin collection case 21 is full with coins, then the blocking device 1432 of the second motor set 14 will output a signal to activate the motor 142 of the second motor set 14 commanding the master roller 1431, the blocking device 1432 and the slave roller 1433 in orderly fashion, for making the partition plate 1125 to close the over loaded coin channel 1124. Furthermore, when the coin collection case 21 of the coin ejecting unit 2 is full with the coins 3, the motor 132 of the first motor set 13 will activate the biasing protruded roller 133 for rotating, to make the edge of the second protruded roller 1332 rest against the coin over-load dispensing plate 1123, and the coin over-load dispensing plate 1123 will rotate outwardly to rest against the back face of the leading face 151 of the dispensing plate 15 and in incline position. Meanwhile, the coin 3 can be led by the coin identifying plate 1122 and the coin over-load dispensing plate 1123 to enter the groove 1121 of the collecting area 112, then the coin 3 enters into the preset collecting channel 22 which located on a side of the coin ejecting unit 2 from the rear side of the base plate 141 of the second motor set 14, and finally, the coin 3 collected into a coin collection case 5 located at an exit of the collecting channel 22 to separate the real coins from the phony ones.

While the invention has been described in conjunction with a specific best mode, it is to be understood that many alternatives, modifications, and variations will be apparent to those skilled in the art in light of the a foregoing description. Accordingly, it is intended to embrace all such alternatives, modifications, and variations, which fall within the spirit and scope of the included claims. All matters set forth herein or shown in the accompanying drawings are to be interpreted in an illustrative and non-limiting sense.

What the invention claimed is:

1. A coin differentiating unit of a coin dispenser, comprising:
a case, comprising a differentiation area and a coin collection area, wherein the differentiation area comprises an insertion slot at an edge portion and the coin collection area comprises a groove, the groove comprises a coin identifying plate and a coin over-load dispensing plate, and a plurality of coin channels is formed at a lower portion, wherein each of the coin channels are separated from the other by a distance;
a detecting device is disposed in the differentiation area of the case;
a first motor set is positioned on a rear side of said coin collection area of the case;
a first motor set comprises a motor which comprises a biasing protruded roller, and said biasing protruded roller is set against said coin identifying plate and said coin over-load dispensing plate;
a second motor set is formed at the rear side of said differentiation area of the case, a plurality of motors is positioned on a base plate, wherein a roller set is axially disposed on said motor for opening or closing said coin channels of the case;
a dispensing plate is positioned in said collecting area on a surface of the case for allowing said detecting device to identify an inserted coin through the insertion slot; and
a means for opening or closing said coin identifying plate and said coin over-load dispensing plate to lead said inserted coin.

2. The coin differentiating unit of claim 1, wherein the detecting device comprises a circuit board, and a plurality of detecting elements disposed on said circuit board.

3. The coin differentiating unit of claim 1, wherein the detecting device comprises an entrance lid on the upper side, and said entrance lid is positioned at a corresponding to said insertion slot of the case.

4. The coin differentiating unit of claim 1, wherein said motor of the first motor set is positioned on a base.

5. The coin differentiating unit of claim 1, wherein said biasing protruded roller of the first motor set comprises a first protruded roller and a second protruded roller axially disposed on the first protruded roller, wherein a radius of the first protruded roller is larger than a radius of the second protruded roller.

6. The coin differentiating unit of claim 1, wherein the roller set of the second motor set comprises two master rollers, said master rollers comprise a blocking device, and said blocking device is axially connected to two slave rollers.

7. The coin differentiating unit of claim 1, wherein the dispensing plate comprises a blocking plate, which projects from its surface.

8. The coin differentiating unit of claim 1, wherein the dispensing plate comprises a leading face extended outwardly from one of its sides.

9. The coin differentiating unit of claim 1, wherein the coin dispenser combines with a coin ejecting unit positioned at a bottom.

10. The coin differentiating unit of claim 9, wherein said coin ejecting unit comprises a coin collection case.
